(19) United States
(12) Patent Application Publication
(10) Pub. No.: US 2026/0321977 A1
(43) Pub. Date: Oct. 15, 2026

(54) MULTI-BAND ANTENNAS HAVING HIGHLY INTEGRATED CROSS-POLARIZED DIPOLE RADIATING ELEMENTS THEREIN

(71) Applicant: Outdoor Wireless Networks LLC, Claremont, NC (US)

(72) Inventors: Haifeng LI, Allen, TX (US); Peter J. BISIULES, LaGrange Park, IL (US)

(21) Appl. No.: 19/101,301

(22) PCT Filed: Aug. 1, 2023
(86) PCT No.: PCT/US2023/071389

§ 371 Date: Feb. 5, 2025

Related U.S. Application Data
(60) Provisional application No. 63/370,523, filed on Aug. 5, 2022.

(51) Int. Cl. H01Q 5/392; H01Q 1/52; H01Q 9/28; H01Q 19/10

(52) U.S. Cl. CPC H01Q 5/392; H01Q 1/523; H01Q 9/285; H01Q 19/108

(57) ABSTRACT

A multi-band antenna includes a relatively low-band cross-dipole radiating element including first through fourth radiating arms, and first through fourth relatively high-band cross-dipole radiating arms in respective first through fourth openings within the first through fourth radiating arms. The first through fourth relatively high-band cross-dipole radiating arms and the first through fourth radiating arms of the relatively low-band cross-dipole radiating element are coplanar. First through fourth isolation frames are provided within the first through fourth openings, respectively. A dielectric substrate is provided, upon which: (i) the first through fourth relatively high-band cross-dipole radiating arms, (ii) the first through fourth radiating arms of the relatively low-band cross-dipole radiating element, and (iii) the first through fourth isolation frames within the first through fourth openings, respectively, are patterned as metallized traces.

### FIELD OF THE INVENTION

The present invention generally relates to cellular communication systems and, more particularly, to base station antennas (BSAs) utilized in cellular and other communication systems.

### BACKGROUND

Cellular communications systems are well known in the art. In a cellular communications system, a geographic area is often divided into a series of regions that are referred to as “cells” which are served by respective base stations. The base station may include one or more base station antennas that are configured to provide two-way radio frequency (“RF”) communications with mobile subscribers that are within the cell served by the base station. In many cases, each base station is divided into “sectors.” In perhaps the most common configuration, a hexagonally shaped cell is divided into three 120° sectors, and each sector is served by one or more base station antennas that have an azimuth Half Power Beamwidth (HPBW) of approximately 65°. Typically, the base station antennas are mounted on a tower or other raised structure, with the radiation patterns (also referred to herein as “antenna beams”) that are generated by the base station antennas directed outwardly. Base station antennas are often implemented as linear or planar phased arrays of radiating elements.

In order to accommodate the ever-increasing volume of cellular communications, cellular operators have added cellular service in a variety of new frequency bands. While in some cases it is possible to use linear arrays of so-called “wide-band” or “ultra wide-band” radiating elements to provide service in multiple frequency bands, in other cases it is necessary to use different linear arrays (or planar arrays) of radiating elements to support service in the different frequency bands. In the early years of cellular communications, each linear array was typically implemented as a separate base station antenna.

As the number of frequency bands has proliferated, and increased sectorization has become more common (e.g., dividing a cell into six, nine or even twelve sectors), the number of base station antennas deployed at a typical base station has increased significantly. However, due to, for example, local zoning ordinances and/or weight and wind loading constraints for the antenna towers, there is often a limit as to the number of base station antennas that can be deployed at a given base station. In order to increase capacity without further increasing the number of base station antennas, so-called multi-band base station antennas have been introduced in recent years in which multiple linear arrays of radiating elements are included in a single antenna. One very common multi-band base station antenna design is the RVV antenna, which includes one linear array of “low-band” radiating elements that are used to provide service in some or all of the 694-960 MHz frequency band (which is often referred to as the “R-band”) and two linear arrays of “high-band” radiating elements that are used to provide service in some or all of the 1695-2690 MHz frequency band (which is often referred to as the “V-band”). These linear arrays are mounted in side-by-side fashion.

There is also significant interest in R2V4 base station antennas, which refer to base station antennas having two linear arrays of low-band radiating elements and four linear arrays of high-band radiating elements. R2V4 antennas, however, are challenging to implement in a commercially acceptable manner because achieving a 65° azimuth HPBW antenna beam in the low-band typically requires low-band radiating elements that are at least 200 mm wide. When two low-band linear arrays are placed side-by-side, with two high-band linear arrays arranged therebetween and the other two high-band linear arrays arranged outside the two low-band linear arrays, then the base station antenna may have a width of perhaps 600-760 mm. Such a large antenna may have very high wind loading, may be very heavy, and/or may be expensive to manufacture. Operators would prefer base station antennas having narrower widths based on higher degrees of multi-band array integration.

### SUMMARY

A highly integrated multi-band antenna according to an embodiment of the invention includes: (i) a first dipole radiating element having a first pair of radiating arms extending forwardly of an underlying reflector, and (ii) a second dipole radiating element having a second pair of radiating arms extending within an opening (e.g., closed-loop) in a first one of the first pair of radiating arms. According to some of these embodiments, an electrically conductive (and “floating”) isolation frame is also provided, which surrounds the second pair of radiating arms, and the first and second pairs of radiating arms are coplanar. In addition, the first and second pairs of radiating arms and the isolation frame may be patterned on a forward facing surface of a dielectric substrate (e.g., PCB board). The first one of the first pair of radiating arms and the electrically conductive isolation frame may also be configured as polygonal-shaped (e.g., rectangular-shaped) loops.

According to further embodiments, a multi-band antenna may include: (i) a dipole radiating element having first and second radiating arms extending forwardly of an underlying reflector, (ii) a first cross-polarized dipole radiating element having a pair of radiating arms extending within an opening in the first radiating arm, (iii) a second cross-polarized dipole radiating element having a pair of radiating arms extending within an opening in the second radiating arm, and (iv) a first isolation frame surrounding the pair of radiating arms of the first cross-polarized dipole radiating element, and extending within the opening in the first radiating arm. In addition, the first and second radiating arms, the pair of radiating arms of the first cross-polarized dipole radiating element, and the first isolation frame are patterned as coplanar metal traces on a forward facing surface of a dielectric substrate. Moreover, in some of these embodiments, a forward facing surface of the reflector may have first regions spaced closer to the radiating arms of the first and second cross-polarized radiating elements relative to second regions extending opposite the first and second radiating arms, to thereby operate as a frequency-selective surface (FSS).

According to further embodiments of the invention, a multi-band antenna includes a relatively low-band cross-dipole radiating element including first through fourth radiating arms, and first through fourth relatively high-band cross-dipole radiating arms extending within respective first through fourth openings within the first through fourth radiating arms. In some of these embodiments, the first through fourth relatively-high band cross-dipole radiating arms, and the first through fourth radiating arms of the relatively low-band cross-dipole radiating element are coplanar. In addition, to improve the electrical properties of the multi-band antenna and provide some degree of cloaking to the relatively low-band cross-dipole radiating element, first through fourth “electrically floating” isolation frames may be provided within the first through fourth openings, respectively. Furthermore, the first through fourth radiating arms of the relatively low-band cross-dipole radiating element (e.g., operating in a frequency range of 694 MHz to 960 MHz) may operate to provide cloaking with respect to radiation provided by the first through fourth relatively high-band cross-dipole radiating arms (e.g., operating in a frequency range of 1695 MHz to 2690 MHZ).

According to further aspects of these embodiments, a dielectric substrate (e.g., PCB board) may be provided, upon which: (i) the radiating arms of the first through fourth relatively-high band cross-dipole radiating elements, (ii) the first through fourth radiating arms of the relatively low-band cross-dipole radiating element, and (iii) the first through fourth isolation frames within the first through fourth openings, respectively, are patterned as metallized traces. And, in further embodiments, this dielectric substrate may be supported by a feed stalk, which extends forwardly of an underlying reflector. A forward facing surface of the reflector may also have first regions (e.g., floating “ground” boxes) spaced closer to the first through fourth relatively-high band cross-dipole radiating arms relative to “grounded” second regions extending opposite the first through fourth radiating arms of the relatively low-band cross-dipole radiating element. In addition, the first (second, third, and fourth) isolation frame may be spaced closer to an outer perimeter of the first (second, third, and fourth) relatively high-band cross-dipole radiating arms relative to an inner perimeter of the first (second, third, and fourth) radiating arm of the relatively low-band cross-dipole radiating element.

### BRIEF DESCRIPTION OF THE DRAWINGS

FIG. 1A is a plan view of a multi-band antenna according to an embodiment of the invention.

FIG. 1B is a side view of the multi-band antenna of FIG. 1A, which includes “ground” plane boxes positioned rearwardly of relatively high-band cross-dipole radiating arms.

FIG. 1C is a perspective view of a quad-arrangement of the “ground” plane boxes illustrated by FIG. 1B.

FIG. 2A is a front perspective view of a multi-band antenna with feed stalk, according to an embodiment of the invention.

FIG. 2B is a rear perspective view of the multi-band antenna of FIG. 2A.

FIG. 3 is a plan view of a base station antenna that utilizes multiple columns of the multiband antenna of FIG. 1A, which are integrated with relatively high-band radiating elements, according to an embodiment of the invention.

FIG. 4A is a perspective view of an array of modified “ground” plane boxes with cutouts, which may be used in the multi-band antenna of FIGS. 2A-2B, according to an embodiment of the invention.

FIG. 4B is a perspective view of an array of modified “ground” plane boxes with cutouts, which may be used in the multi-band antenna of FIGS. 2A-2B, according to an embodiment of the invention.

FIGS. 5A-5D are plan views of sheet metal reflector segments, which may be used to form a frequency selective surface (FSS) of a reflector, according to embodiments of the invention.

### DETAILED DESCRIPTION

The present invention now will be described more fully with reference to the accompanying drawings, in which preferred embodiments of the invention are shown. This invention may, however, be embodied in many different forms and should not be construed as being limited to the embodiments set forth herein; rather, these embodiments are provided so that this disclosure will be thorough and complete, and will fully convey the scope of the invention to those skilled in the art. Like reference numerals refer to like elements throughout.

It will be understood that, although the terms first, second, third, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

The terminology used herein is for the purpose of describing particular embodiments only and is not intended to be limiting of the present invention. As used herein, the singular forms “a,” “an” and “the” are intended to include the plural forms as well, unless the context clearly indicates otherwise. It will be further understood that the terms “comprising”, “including”, “having” and variants thereof, when used in this specification, specify the presence of stated features, steps, operations, elements, and/or components, but do not preclude the presence or addition of one or more other features, steps, operations, elements, components, and/or groups thereof. In contrast, the term “consisting of” when used in this specification, specifies the stated features, steps, operations, elements, and/or components, and precludes additional features, steps, operations, elements and/or components.

Unless otherwise defined, all terms (including technical and scientific terms) used herein have the same meaning as commonly understood by one of ordinary skill in the art to which the present invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

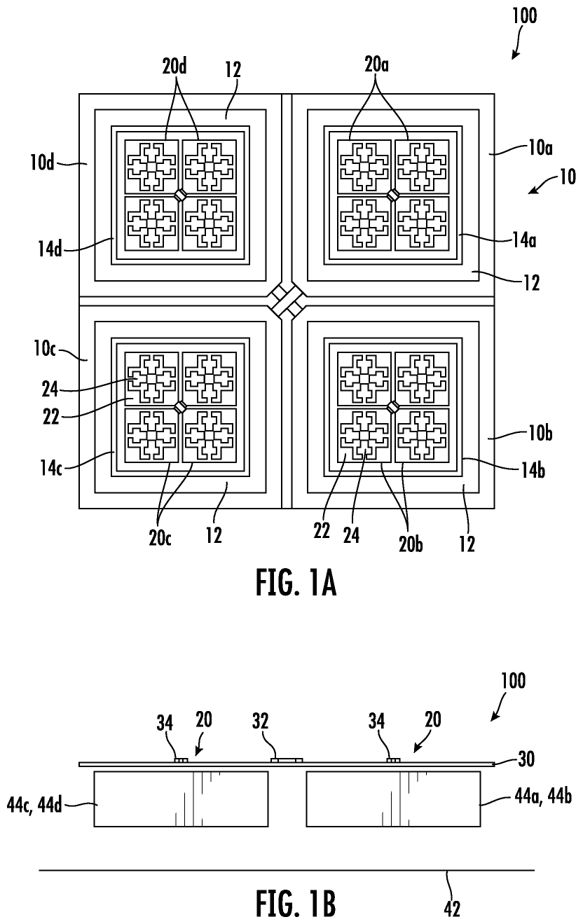

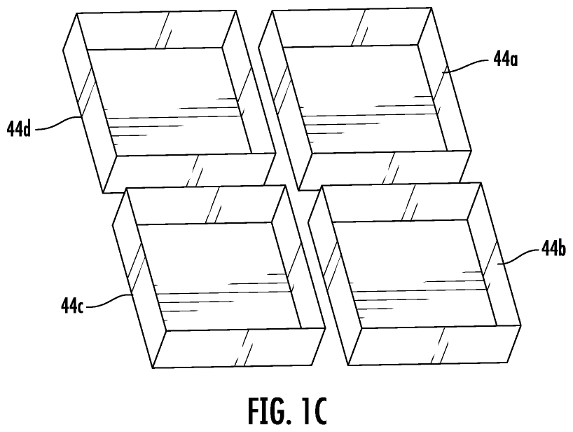

Referring now to FIGS. 1A-1C, a multi-band antenna 100 according to an embodiment of the invention is illustrated as including a relatively low-band cross-dipole radiating element 10, and first through fourth relatively high-band cross-dipole radiating arms 20a, 20b, 20c, 20d associated with a quad arrangement of first through fourth relatively high-band radiating elements 20, respectively. As shown, the relatively low-band cross-dipole radiating element 10 includes first and third polygonal-shaped radiating arms 10a, 10c associated with a first dipole radiating element (e.g., +45°), and second and fourth polygonal-shaped radiating arms 10b, 10d associated with a second dipole radiating element (e.g., −45°). In addition, the first through fourth relatively high-band cross-dipole radiating arms 20a, 20b, 20c, 20d are positioned within first through fourth openings 12 within the first through fourth radiating arms 10a, 10b, 10c, 10d, respectively, along with corresponding first through fourth “electrically floating” isolation frames 14a, 14b, 14c, 14d. Advantageously, these isolation frames 14a, 14b, 14c, 14d, which may be spaced closer to the relatively high-band cross-dipole radiating arms 20a, 20b, 20c, 20d relative to the relatively low-band cross-dipole radiating arms 10a, 10b, 10c, 10d, can operate to improve the electrical properties (e.g., beam pattern, cross-band isolation) of the relatively low and high band radiating elements 10, 20, and provide some degree of cloaking to the relatively low-band cross-dipole radiating element 10. The sizes of the isolation frames 14a-14d may also influence an impedance match to corresponding ones of the high-band cross-dipole radiating arms 20a, 20b, 20c, 20d, but the spacing therebetween should be sufficient to inhibit strong coupling by being somewhat greater than a spacing between each of the four generally square-shaped radiating arms with a corresponding one of the high-band cross-dipole radiating arms 20a, 20b, 20c, 20d. Although not wishing to be bound by any particular implementation, the four radiating arms 10a, 10b, 10c, 10d of the relatively low-band cross-dipole radiating element 10 may be configured and dimensioned to operate within a frequency range of about 694 MHz to about 960 MHz, whereas the first through fourth relatively high-band cross-dipole radiating arms 20a, 20b, 20c, 20d may be configured and dimensioned to operate within a frequency range of about 1695 MHz to about 2690 MHz, however, other bands and frequency ranges are also feasible.

As shown best by FIGS. 1A-1B, a planar substrate 30, such as a dielectric printed circuit board (PCB), is provided, and the first through fourth radiating arms 10a, 10b, 10c, 10d, the first through fourth cross-dipole radiating arms 20a, 20b, 20c, 20d, and the first through fourth isolation frames 14a, 14b, 14c, 14d are patterned as metallized traces on a forward-facing surface of the substrate 30. In particular, the first through fourth radiating arms 10a, 10b, 10c, 10d and the first through fourth isolation frames 14a, 14b, 14c, 14d may be patterned as rectangular-shaped metal loops, whereas the first through fourth relatively high-band cross-dipole radiating arms 20a, 20b, 20c, 20d may be patterned to have generally rectangular-shaped outer perimeters, with square corner patches 22 and cross-shaped (and inwardly directed) arm extensions 24 within each radiating arm. However, other configurations of the radiating arms are also possible according to other embodiments of the invention. In addition, the criss-crossing metal jumpers 32, 34 on the forward-facing surface of the substrate 30 may be used for simulation modeling/testing, but otherwise omitted from a commercial embodiment.

The multi-band antenna 100 may further be provided with a hybrid reflector 40 extending opposite a rear facing surface of the substrate 30, as shown by FIGS. 1B-1C. This hybrid reflector 40 is illustrated as including a planar ground plane reflector 42 and a quad-arrangement of electrically conductive boxes 44a-44d (or elevated sheet metal segments), which may be mounted to extend more closely adjacent the rear facing surface of the substrate 30. In particular, each box 44a, 44b, 44c, 44d may extend diametrically opposite and below a corresponding arrangement of high-band cross-dipole radiating arms 20a, 20b, 20c, 20d, respectively. In some embodiments, these boxes 44a-44d may be configured to operate as three-dimensional (3D) electrically ‘floating” ground plane segments that are spaced more closely to the substrate 30 relative to the ground plane reflector 42, such that first regions of the hybrid reflector 40 are spaced closer to the first through fourth relatively-high band cross-dipole radiating arms 20a, 20b, 20c, 20d relative to ”grounded“ second regions extending opposite the first through fourth radiating arms 10a, 10b, 10c, 10d.

Moreover, each of the boxes 44a-44d may be configured with hardware and apertures therein (not shown) that supports the vertical routing of feed signal lines (e.g., 2× coaxial cables, etc.) from adjacent the planar reflector 42 to the substrate 30 and corresponding feed signal traces associated with the relatively high-band cross-dipole radiating arms 20a, 20b, 20c, 20d. For example, in some of these embodiments, the outer conductors of each of the pair of coaxial cables (associated with each of the four high-band radiating elements) may be electrically connected, or otherwise sufficiently coupled, to a corresponding one of the four boxes 44a, 44b, 44c, 44d, which may remain electrically “floating” relative to a corresponding one of the first through fourth radiating arms 10a, 10b, 10c, 10d (and each other). According to further embodiments, the boxes 44a, 44b, 44c, 44d may be provided with slots or cutouts (not shown) to enhance their frequency selective surface (FSS) and cloaking characteristics, and may have lateral dimensions that correspond to (or are greater than) the lateral dimensions of the isolation frames 14a-14d, yet smaller than the lateral dimensions of the first through fourth radiating arms 10a, 10b, 10c, 10d (e.g., to prevent excessive coupling therebetween).

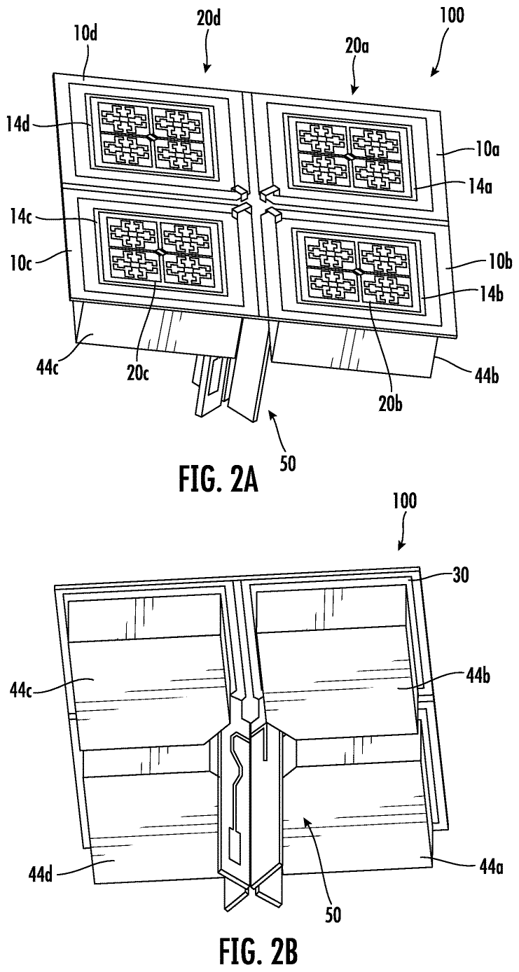

Furthermore, as shown by FIGS. 2A-2B, the vertical feed signal routing associated with the relatively low-band cross-dipole radiating element 10 may be provided by a conventional feed stalk 50, which extends forwardly of (and possibly through) an underlying ground plane reflector 42 (see, e.g., FIG. 1B). In alternative embodiments of the invention, this feed stalk 50 may be modified to include additional signal routing (not shown) to the feed signal traces associated with the relatively high-band cross-dipole radiating arms 20a, 20b, 20c, 20d. And, as shown best by FIG. 2B, to accommodate the lateral dimensions of the vertical feed stalk 50, centrally located corners may be omitted from the quad-arrangement of electrically conductive boxes 44a′-44d′.

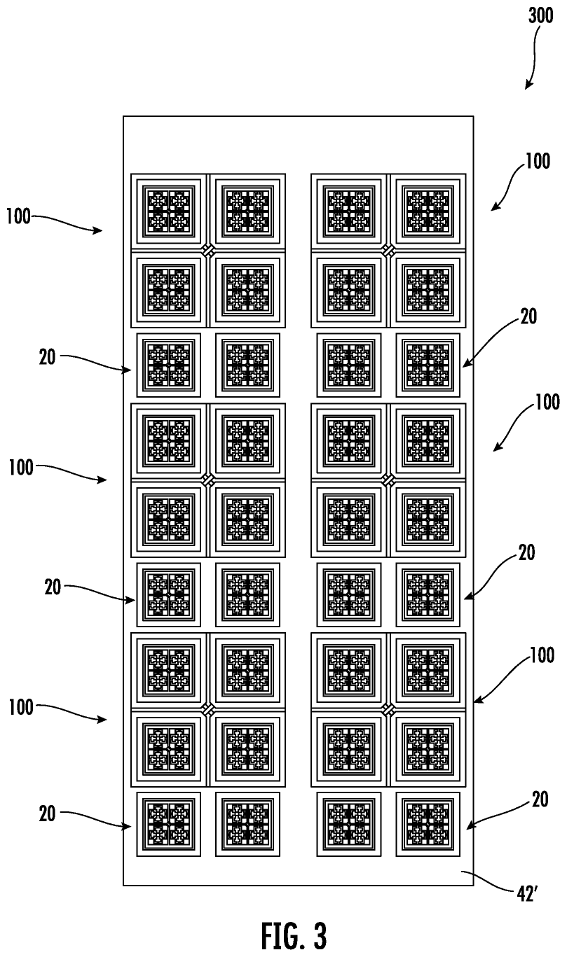

Referring now to FIG. 3, a relatively narrow base station antenna (BSA) 300 that includes three rows and two side-by-side columns of the multiband antenna 100 of FIGS. 1A-1C and 2A-2B, is illustrated. Within each column, three separate rows of relatively high band radiating elements 20 (i.e., without low-band inclusion) are also provided with underlying “ground” plane boxes (not shown). Advantageously, the use of the multiband antennas 100 enables a BSA 300 that may fit within a narrower housing (not shown), while still maintaining relatively high cross-band isolation.

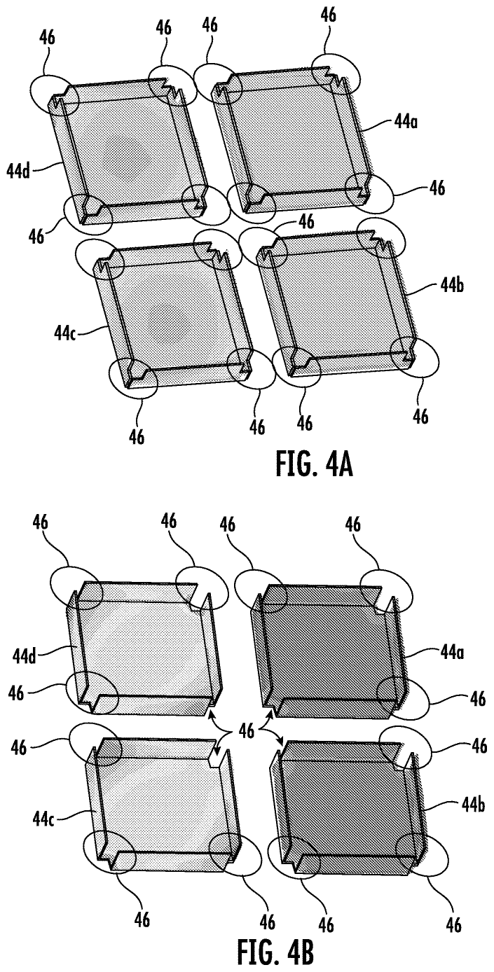

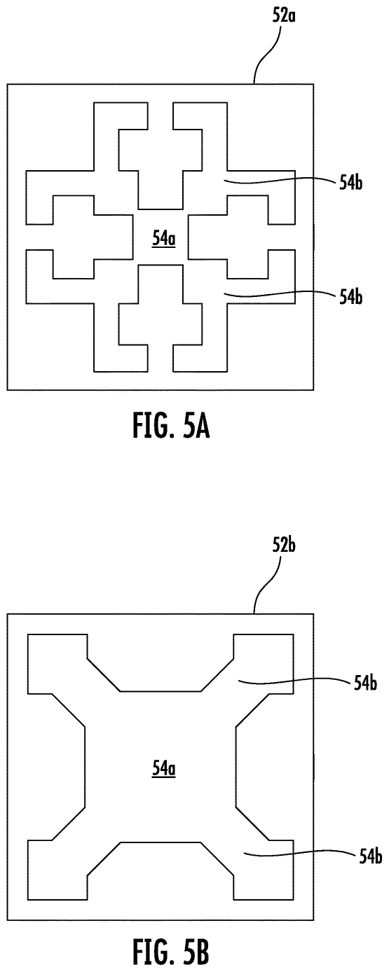

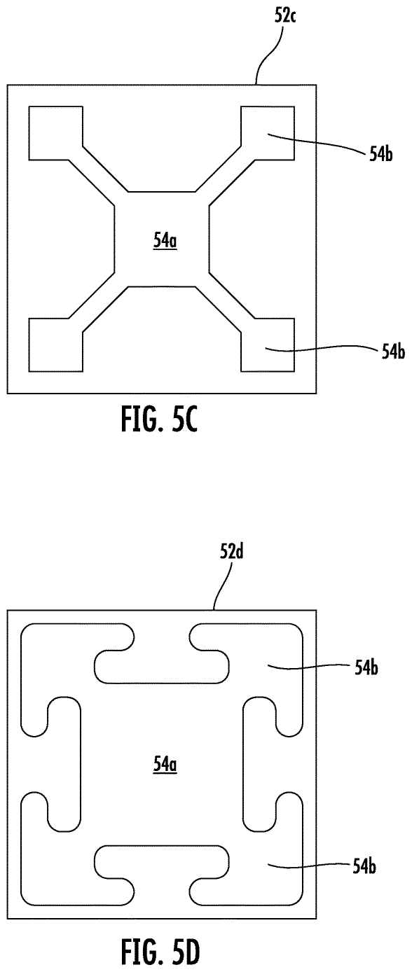

Finally, as shown by FIGS. 4A-4B, the “ground” plane boxes 44a-44d of FIG. 1C may be modified to include corner “cutouts” 46 of varying size to improve high band isolation between the relatively high-band cross-dipole radiating elements 20 within each multiband antenna 100. In addition, as shown by FIGS. 5A-5D, sheet metal reflector segments 52a, 52b, 52c and 52d having varying-shaped cutouts may be used to form a frequency selective surface (FSS) of a reflector, with each planar segment (52a, 52b, 52c or 52d) replacing an elevated “ground” plane box 44a-44d, and each cutout including a centrally-located and generally polygonal-shaped opening 54a with four radially-extending openings 54b (e.g., arrow-shaped, Y-shaped, V-shaped) directed towards the four corners of each segment. Moreover, in alternative embodiments, the sheet metal reflector segments 52a, 52b, 52c and 52d may be configured using patterned metallization (single-sided or dual-sided) on a planar dielectric substrate (e.g., PCB board).

In the drawings and specification, there have been disclosed typical preferred embodiments of the invention and, although specific terms are employed, they are used in a generic and descriptive sense only and not for purposes of limitation, the scope of the invention being set forth in the following claims.

1. An antenna, comprising:
a first dipole radiating element having a first pair of radiating arms extending forwardly of a reflector;
a second dipole radiating element having a second pair of radiating arms extending within an opening in a first one of the first pair of radiating arms; and
an electrically conductive isolation frame surrounding the second pair of radiating arms.

2. The antenna of claim 1, wherein the first and second pairs of radiating arms are coplanar.

3. The antenna of claim 1, wherein the first and second pairs of radiating arms and isolation frame are coplanar.

4. The antenna of claim 3, wherein the first and second pairs of radiating arms and isolation frame are patterned on a forward facing surface of a dielectric substrate.

5. The antenna of claim 3, wherein the first one of the first pair of radiating arms is configured as a rectangular-shaped loop.

6. The antenna of claim 5, wherein the electrically conductive isolation frame is configured as a rectangular-shaped loop.

7. A multi-band antenna, comprising:
a dipole radiating element including first and second radiating arms extending forwardly of a reflector; and
a first cross-polarized dipole radiating element having a pair of radiating arms extending within an opening in the first radiating arm.

8. The antenna of claim 7, further comprising:
a first isolation frame surrounding the pair of radiating arms of the first cross-polarized dipole radiating element, and extending within the opening in the first radiating arm.

9. The antenna of claim 7, further comprising:
a second cross-polarized dipole radiating element having a pair of radiating arms extending within an opening in the second radiating arm.

10. The antenna of claim 8, wherein the first and second radiating arms, the pair of radiating arms of the first cross-polarized dipole radiating element, and the first isolation frame are patterned on a forward facing surface of a dielectric substrate.

11. The antenna of claim 8, wherein the first and second radiating arms, the pair of radiating arms of the first cross-polarized dipole radiating element, and the first isolation frame are coplanar.

12. The antenna of claim 9, wherein the first and second radiating arms, and the radiating arms of the first and second cross-polarized dipole radiating elements are coplanar; and wherein a forward facing surface of the reflector has first regions spaced closer to the radiating arms of the first and second cross-polarized radiating elements relative to second regions extending opposite the first and second radiating arms.

13. The antenna of claim 12, wherein the forward facing surface of the reflector functions as a frequency-selective surface (FSS).

14. A multi-band antenna, comprising:
a relatively low-band cross-dipole radiating element including first through fourth radiating arms; and
first through fourth relatively high-band cross-dipole radiating arms in respective first through fourth openings within the first through fourth radiating arms.

15. The antenna of claim 14, wherein the first through fourth relatively high-band cross-dipole radiating arms and the first through fourth radiating arms of the relatively low-band cross-dipole radiating element are coplanar.

16. The antenna of claim 15, further comprising first through fourth isolation frames within the first through fourth openings, respectively.

17. The antenna of claim 16, further comprising a dielectric substrate upon which: (i) the first through fourth relatively high-band cross-dipole radiating arms, (ii) the first through fourth radiating arms of the relatively low-band cross-dipole radiating element, and (iii) the first through fourth isolation frames within the first through fourth openings, respectively, are patterned as metallized traces.

18. The antenna of claim 17, wherein the dielectric substrate is supported by a feed stalk, which extends forwardly of an underlying reflector; and wherein a forward facing surface of the reflector has first regions spaced closer to the first through fourth relatively high-band cross-dipole radiating arms relative to second regions extending opposite the first through fourth radiating arms of the relatively low-band cross-dipole radiating element.

19. The antenna of claim 18, wherein the forward facing surface of the reflector functions as a frequency-selective surface (FSS).

20. The antenna of claim 16, wherein the first isolation frame is spaced closer to an outer perimeter of the first relatively high-band cross-dipole radiating arms relative to an inner perimeter of the first radiating arm of the relatively low-band cross-dipole radiating element.

21.-25. (canceled)
